(19) United States
(12) Patent Application Publication
(10) Pub. No.: US 2018/0152911 A1
(43) Pub. Date: May 31, 2018

(54) SYSTEM, METHOD, DEVICE AND NODE IN A POSITIONING NETWORK ADAPTED TO ENABLE VOICE COMMUNICATION

(71) Applicant: NiDa Tech Sweden AB, Malmo (SE)

(72) Inventor: Håkan Dackefjord, Älvsjö (SE)

(21) Appl. No.: 15/880,589

(22) Filed: Jan. 26, 2018

Related U.S. Application Data
(63) Continuation of application No. PCT/SE2016/050734, filed on Jul. 29, 2016.

(30) Foreign Application Priority Data
Jul. 29, 2015 (SE) 1551048-0

(51) Int. Cl. H04W 64/00; G01S 5/02

(52) U.S. Cl. CPC H04W 64/00; G01S 5/0289

(57) ABSTRACT

A system, method, node, and device arranged to provide a network for positioning of a device, wherein the system, method, node, and device further is adapted to enable transmission of voice communication through a first wireless communication frequency in the range between 300 and 1000 MHz. The node and the device of the system are adapted to communicate voice communication over said first wireless communication frequency, the node and a main unit are adapted to communicate through a second communication frequency, and the node is adapted to modulate the voice communication from said first wireless communication frequency to said second communication frequency.

### TECHNICAL FIELD

The present invention relates generally to a system, method, device, and node in a positioning network, wherein the system, method, node, and device are adapted to enable voice communication.

### BACKGROUND ART

Cell phone coverage from a cellular network was for a long time a necessity for using any mobile phone. With the development of telephones comprising additional functionality utilizing other networks, such as WLAN (Wireless Local Area Network) and Bluetooth, the phone became more than just a phone. The introduction of such features enabled for phones to be used, at least for some applications, over the local network instead of the cellular network.

Development of mobile networks for data communication has resulted in increased speeds of transmission for data and that the coverage area where the data connection can be used nowadays is significantly more extensive than previously. Meanwhile the technology for telephone conversations has evolved in a different direction. Although the number of users has increased and cell towers are more common now than before the data coverage has increased partly through allowing users to use different networks, such as a private WLANs, to increase the coverage. This especially in indoor environments wherein other factors than distance to the cell towers is of high importance.

The systems for telephone conversations have changed but the overall functionality for telephone conversations is the same. Traditional telephone conversations do not utilize WLAN or other private networks to increase coverage in the same way that data connections do. Instead Voice over Internet Protocol (VoIP), also known as broadband telephony, IP telephony, and internet telephony, has been introduced as an alternative, an alternative that is not always compatible with the traditional telephone conversation systems.

Thereby, prior art describes communication of voice and sound over private and public data networks through VoIP wherein a network such as the Internet is used to communicate telephone conversations in real time. The VoIP systems are used especially through WLAN/LAN and are communications between two different VoIP instances, not a traditional phone and a VoIP instance. The systems are not at all adapted to increase range, rather to reduce the cost of performing the call.

In prior art it is further known to arrange nodes to create systems for positioning of objects, such as indoor positioning systems wherein for example base stations can be used as nodes or global positioning systems wherein satellites are arranged in orbit as nodes for enabling positioning of objects.

It is thereby a problem with the prior art solutions that at remote locations, or at skip zones, wherein the cellular network has limited coverage data transmission might be solved through WLAN or a similar solution but the problem of calling and/or receiving calls remains. It is furthermore a problem with prior art solutions that WLAN, especially WiFi or Bluetooth solutions, have very limited range. Users reachable through VoIP services are limited in individuals they can call which is yet another problem in the prior art.

Prior art solutions for enhancing wireless communication for voice communicate furthermore encounters additional problems when environmental, safety, and building technology is combined and developed. For example, when constructing modern houses the technology for enhancing the security and living environment for the residents comprises features such as safety doors, fireproof doors, and sound reducing windows. In addition, one of the key areas of improvement when building new apartments and houses is to reduce the cost for heating the indoor area resulting in an increased thickness of walls. Although the aforementioned features increases the living standard and quality of houses it decreases the cellphone coverage inside those new buildings. In many cases the insulation is so good that the coverage from mobile networks, such as the cellphone network, is completely cancelled creating a skip zone in every apartment or house. Prior art solutions such as adding a GSM, 3G, or LTE repeater inside the house or apartment is not a recommended solution due to the increased electromagnetic radiation reaching an unacceptable level.

It would thereby be beneficial to provide a solution addressing at least some of the aforementioned problems.

### SUMMARY OF INVENTION

An object of the present invention is to provide a solution for enhancing the range for voice communication. Another object of the present invention is to provide a solution that utilizes different frequencies for a single communication. Yet another object of the present invention is to provide a cost effective solution enabling users to make and receive calls outside of the regular telephone communication network. It is further an advantage with the present solution that the system combines functionality wherein both positioning and voice communication can be conducted through the same frequency, the frequency being a frequency with long range but relatively low data transfer in relation to conventional technologies, such as WiFi.

Systems for positioning of objects are beneficially systems with cover areas larger than the areas achieved through the conventional range that systems adapted for local area data communication have. Most of the data communication conducted in a commercial or domestic area such as an office or a home are conducted within the limited space of for example a building, an office, or an apartment. It is beneficial if positioning of devices works also outside the range of local area communication networks such as the networks described above.

Thereby it is one advantage with the present solution that voice communication can be performed via a positioning network. The positioning network as will be further described herein is a network utilizing frequencies between 300 MHz and 1000 MHz enabling a range of 10 km or more. This enables a cost effective solution wherein the coverage can be increased, especially the coverage in relation to traditional WiFi and Bluetooth technologies. The technology as disclosed herein has the advantage that the cost for arranging new nodes are merely a fraction of what it would cost to increase the coverage through arranging nodes of a traditional mobile telephone network, such as GSM, 3G, or LTE. Furthermore, nodes in accordance with the appended claims can be arranged by an individual or a company in a similar manner as a WiFi access point enabling for individuals and entities outside of the telecom industry to increase the coverage for their voice communication without a telecom service provider.

Thus, the solution relates to a system, method, node, and device arranged to provide a network for positioning of a device, wherein the system, method, node, and device further is adapted to enable transmission of voice communication through a first wireless communication frequency in the range between 300 and 1000 MHz. The node and the device of the system are adapted to communicate voice communication over said first wireless communication frequency, the node and a main unit are adapted to communicate through a second communication frequency, and the node is adapted to modulate the voice communication from said first wireless communication frequency to said second communication frequency.

According to an embodiment is a node arranged to provide a network for positioning of a device, wherein the node further is adapted to enable transmission of voice communication through a first wireless communication frequency in the range between 300 and 1000 MHz. The node further comprises means for communicating with a main unit through a second wireless communication frequency and is adapted to modulate a voice communication from said first wireless communication frequency to said second wireless communication frequency. The node is further configured to transmit the voice communication to said main unit.

It is one advantage with the present solution that the node is a combination node adapted both to provide a positioning network and to enable voice communication. Through allowing multiple functionality through one node it is possible to reduce cost, get better coverage, and provide a solution that is more user friendly.

It is further an advantage with the present solution that the communication between the node and the device is conducted at a frequency between 300 and 1000 MHz. The frequency range allows for better range especially in areas with many objects that blocks the line of sight. High frequencies allows for high amount of data to be transferred with high speed over short distances. Frequencies used for WiFi are thereby above 2 GHz and adapted to communicate relatively high amount data over short distances. For performing a voice call it is not necessary to have bandwidth that is as high as for WiFi but the range is more important. The same applies for positioning systems why the combination system as described herein is beneficial from many perspectives. The first frequencies as described above furthermore comprise better characteristics regarding coverage in areas with many objects blocking the clear line of sight. This is due to that the penetration capability of radio waves are better below 1 GHz than above. This is a particular advantage in relation to technologies utilizing satellites, such as GPS, wherein a clear line of sight towards the sky is more or less a requirement for the technology to work as intended.

Voice communication is for the purpose of this disclosure any form of data communication comprising voice, including but not limited to traditional telephone conversations in real time. The person skilled in the art understands that voice communication is a form of data. The data capacity for transmitting voice is relatively low in relation to other application areas smartphones are utilized for, such as HD video and other streaming services. However, it should be noted that it is part of the invention that the data communicated comprise voice due to the different advantages the relatively low frequencies between 300 and 1000 MHz provides for this type of communication. Low speed data communication is enabled which is especially beneficial for the transmission of voice communication and the like.

In one embodiment is the second communication frequency transmitted via a physical communication means, such as a cable.

According to an embodiment the voice communication is preserved in a mobile phone format.

According to an embodiment the second wireless communication frequency is a wireless local area network frequency.

It is one advantage with the present solution that the second wireless communication frequency in one embodiment is a conventional WLAN/WiFi frequency enabling that existing infrastructures can be utilized to enhance the coverage of the present solution. In one embodiment is the node adapted to communicate with multiple WLAN access points in order to balance the load between them.

According to an embodiment the second wireless communication frequency is a frequency adapted for ZigBee, Bluetooth, or any other frequency adapted for data communication.

According to an embodiment the second wireless communication frequency is a frequency selected from any one of 2.4 GHz, 3.6 GHz, 4.9 GHz, 5 GHz, and 5.9 GHz.

The person skilled in the art understands that the frequencies 2.4 GHz, 3.6 GHz, 4.9 GHz, 5 GHz, and 5.9 GHz are approximate frequencies in accordance with the standards for WLAN, preferably IEEE 802.11 or IEEE 802.11x, wherein x is any one of the known standards such as 802.11a/h/j/n/y/ac/p/ad/p/ah or the like. The person skilled in the art thereby further understands that the frequency might be any one frequency in accordance with the channels available for each frequency mentioned above. For example, 2.4 GHz in one embodiment corresponds to any one of the frequencies 2412, 2417, 2422, 2427, 2432, 2437, 2442, 2447, 2452, 2457, 2462, 2467, 2472, 2484 MHz in accordance with the IEEE 802.11 and the supported channels for 2.4 GHz.

In yet another embodiment the node is connected to a network, such as the internet, through physical connection means. In one embodiment is the physical connection means chosen from any one of Ethernet, USB, power line communication, Ethernet over power, or any other suitable technology.

According to an embodiment the node is configured to transmit a position request to the device, receive a position response from the device, and calculate the distance to the device.

It is one advantage with the present solution that the system for enhancing voice communication range is incorporated to a positioning system. The positioning system provides with a network while allowing for information paths to be studied through knowledge of the position of the device to be tracked. Furthermore, the position information is in one embodiment usable for determining which network that is most suitable to use as well as determining which network to switch a voice communication to if the user changes his or hers position.

According to an embodiment the first wireless communication frequency is used for transmitting the position request.

According to an embodiment the node further comprises means for connecting the node to a conventional power outlet socket.

It is one advantage with the present solution that the node in one embodiment can be attached to a conventional power outlet socket by a user. The technology is in one embodiment compact, cost efficient, and easy to install in a domestic or commercial area, such as a home or an office.

According to an embodiment the node further comprises means for monitoring information paths.

In one embodiment is the node adapted to monitor information paths and provide information about how users utilizes the system. In different embodiments such information may be used to map coverage areas for mobile networks, WiFi networks, and the network the node utilizes wherein the node communicates at frequencies between 300 MHz and 1000 MHz.

According to an aspect a device is arranged in a network for positioning of a device. The device is adapted to communicate with a node through a first wireless communication frequency in the range between 300 and 1000 MHz. The device is adapted to enable voice communication through said first wireless communication frequency when the device is out of range from a cellular network, the device transmit voice communication to said node, and receive voice communication from said node.

According to an embodiment the device is adapted to be connected to a mobile device.

In one embodiment is the device adapted to connect to a mobile device, being any form of mobile device such as a mobile phone or a smart phone. The device is preferably adapted to connect through any form of conventional connection means such as Bluetooth, WiFi, ZigBee, NFC, USB, or any other form of wireless or wired connection means.

According to an embodiment the device is embedded in a mobile device.

According to an embodiment is the device an embedded part of the mobile device. According to another embodiment is the device a third party device arranged to the mobile device as an aftermarket product.

According to an embodiment the device is also out of range of communication through a second wireless communication frequency and the first wireless communication frequency is a frequency with longer range than the second wireless communication frequency.

It is one advantage with the present solution that the mobile device when in range of a cell tower can communicate via a conventional mobile network, such as GSM, 3g, or LTE. When the mobile device, and thereby the device although it can't communicate with the conventional mobile network, is out of range from the conventional mobile network it can communicates via the first wireless communication frequency. For example, a mobile device comprising or connected to a device is outside of range from a conventional mobile network, i.e. out of range from the cell tower. It is also in the vicinity of a WLAN constituting a second wireless frequency, however the device is outside of range from the WLAN as well. The device can communicate via a first wireless communication frequency and thereby a node that in turn is connected to the second wireless frequency and the conventional mobile network.

According to an embodiment the device is adapted to be tracked by a node, receive a position request from the node, and transmit a position response to the node.

According to an embodiment the device is adapted to communicate with a second mobile device connected to a mobile network base station through the node and a main unit.

The wording mobile network, conventional mobile network, cell network, cellular network, mobile network base station, base station, and cell tower are herein used for describing conventional mobile networks and parts thereof, mobile networks could for example be 3G, GSM, or LTE networks.

According to an aspect a system is arranged to provide a network for positioning of a device, the system is further adapted to enable transmission of voice communication through a first wireless communication frequency in the range between 300 and 1000 MHz. The system comprises a node, a device, a main unit, and at least one mobile device. The node and the device are adapted to communicate voice communication over said first wireless communication frequency, the node and the main unit are adapted to communicate through a second wireless communication frequency, and the node is adapted to modulate the voice communication from said first wireless communication frequency to said second wireless communication frequency.

According to an embodiment the main unit further is adapted to communicate with a cellular network.

According to an embodiment the communication technology between the main unit and the cellular network is chosen from any one of GSM, 3G, and LTE.

According to an embodiment the system comprises means for monitoring information paths.

According to an embodiment the system comprises a node.

According to an embodiment the system comprises a device.

According to an aspect of a node arranged to provide a network for positioning of a device. The node is further adapted to enable transmission of voice communication through a first wireless communication frequency in the range between 300 and 1000 MHz. The node further comprises means for communicating with a main unit through a second wireless communication frequency, and the performs the steps:
modulating a voice communication from said first wireless communication frequency to said second wireless communication frequency, and
transmitting the voice communication to said main unit.

The system, method, node, or device wherein the system, method, node, or device further is adapted to modulate the voice communication between VoIP and regular phone service.

According to an embodiment the voice communication is preserved in a mobile phone format.

According to an embodiment the voice communication is already processed.

According to an embodiment the voice communication is transferred without changing any other characteristics than the frequency.

According to an embodiment the voice communication from the main unit is sent over a data network before reaching a second mobile device.

It is one advantage with the node, device, system, and method as described herein that the voice communication is maintained in its original format allowing it to be presented through the conventional telephone network at both the first and second mobile devices that are communicating. The person skilled in the art understands that the first and second mobile devices are used merely for illustration purpose and that a telephone conversation might comprise more than two mobile devices simultaneously.

According to one embodiment the distance to the device is used to determine the output power of the first wireless communication frequency.

According to one embodiment the distance to the node is used to determine the output power of the first wireless communication frequency.

It is one advantage that power can be saved through selecting the output power based on any one of distance, position, or error rate.

According to one embodiment the distance between the node and the device is used to determine the output power of the first wireless communication frequency.

According to one embodiment the node determines an error rate for the voice communication and selects a band of said first wireless communication frequency based on the determined error rate.

According to one embodiment the device determines an error rate for the voice communication and selects a band of said first wireless communication frequency based on the determined error rate.

According to one embodiment the device selects a band of said first wireless communication frequency based on the distance.

According to one embodiment the node selects a band of said first wireless communication frequency based on the distance.

It is one advantage with the present solution that the frequency band can be selected based on a number of input variables, such as distance or error rate. There are regulations that allows for certain frequencies to be used for only a limited time but with high output power meanwhile other frequencies can be used for constant on air transmission but at lower output power.

### BRIEF DESCRIPTION OF DRAWINGS

The invention is now described, by way of example, with reference to the accompanying drawings, in which:

FIG. 1 illustrates a system arranged to provide a network for positioning of a device and adapted for enhancing voice communication.

FIG. 2a illustrates a device arranged in a mobile device.

FIG. 2b illustrates a node with means for connecting said node to a power socket.

FIG. 2c illustrates a main unit.

FIG. 3 illustrates a system arranged to provide a network for positioning of a device and adapted for enhancing voice communication wherein illustrative coverage areas are shown.

FIG. 4 illustrates an illustrative view of a main unit and multiple nodes wherein illustrative coverage areas are shown.

FIG. 5 illustrates mobile devices and a devices wherein a device is coupled to a mobile device.

FIG. 6 illustrates steps formed during voice communication within the system for positioning of a device.

### DESCRIPTION OF EMBODIMENTS

In the following, a detailed description of different embodiments of the node, device, method and, system is disclosed under reference to the accompanying drawings. All examples herein should be seen as part of the general description and are therefore possible to combine in any way of general terms. Individual features of the various embodiments and aspects may be combined or exchanged unless such combination or exchange is clearly contradictory to the overall function of the disclosed node, device, method, and/or system.

Briefly, the solution relates to a method, node, device, and system for enabling voice communication in a system for positioning of a device. The system utilizes frequencies with properties that are beneficial for low speed data communication, positioning, and voice communication.

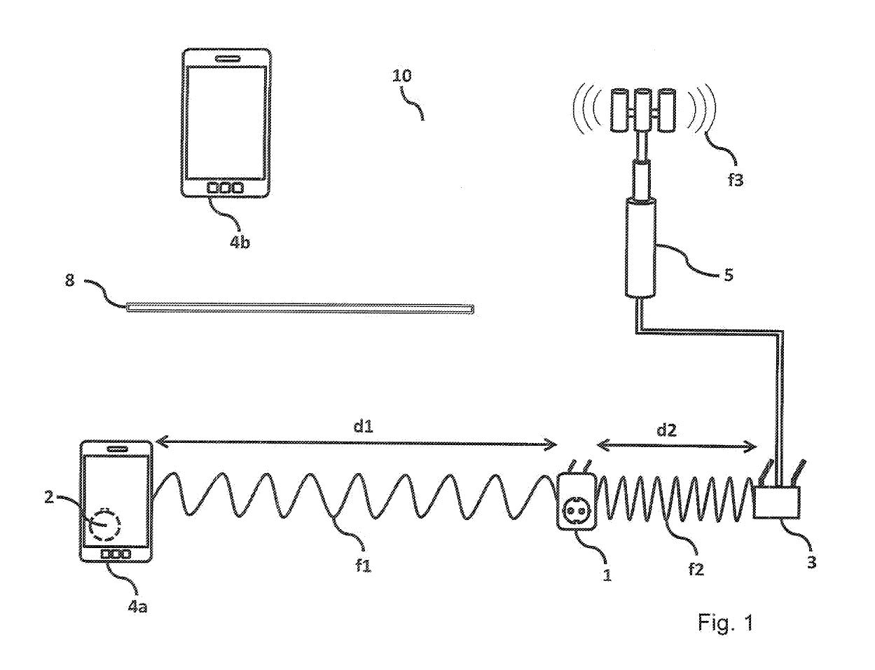

FIG. 1 illustrates a system 10 for positioning of a device wherein the system is adapted to enable voice communication at locations where conventional cellular networks are not available. The cellular network f3 is distributed from one or more base stations 5 and connects mobile devices 4 in a network, generally adapted to be used for both voice and data communication. The mobile network is for enabling data communication generally connected to the Internet wherein other device are connected such as a main unit 3. The main unit 3 can be any form of main unit 3 located in a domestic or commercial area. For the purpose of the solution as described herein is a main unit 3 preferably a WiFi router but it can be any form of small device such as a Bluetooth, Zigbee, or WiFi hotspot. The main unit 3 as described herein is adapted to be a compact main unit 3 and is thereby not to be compared to base stations 5 such as cell towers 5.

The main unit 3 is connected to the Internet or any other form of network, such as a cellular network, either via a cable, fiber, or through some kind of wireless communication such as GSM, 3G, or LTE. The main unit 3 typically have other application areas such as arranging a wireless local area network within the area wherein it is located.

The node 1 is a node generally adapted to position a device 2 through sending a positioning message to the device 2, receive a positioning response, and calculate the distance to the device 2. The node 1 utilizes a network with a first wireless frequency range between 300 and 1000 MHz for sending and receiving the positioning request/response and the network has a good range allowing for better coverage than for example WiFi. If the conditions are beneficial the range can be 10 km or more from a node 1 connected to a conventional power socket.

The node 1 is further adapted to communicate via two different frequencies wherein a first wireless frequency (f1) being the frequency in a range between 300 and 1000 MHz while the second wireless frequency (f2) is another frequency, preferably adapted for communication with an existing network, such as a WiFi network.

The node 1 communicates with a device 2, the device 2 being adapted to communicate via the first wireless frequency f1. The device 2 is in different embodiments a different form of device 2. For example, in one embodiment the device 2 is a positioning tag that is adapted to be connected to a mobile device 4 through for example a cable or Bluetooth. In another embodiment is the device 2 an embedded component of the mobile device 4. The mobile device 4 is a mobile device 4 adapted to perform voice communication, such as a cellphone or smartphone.

FIG. 1 further illustrates a system environment comprising a system 10 according to the present solution. The system environment comprises a first mobile device 4a and a second mobile device 4b. The first mobile device 4a is a mobile device 4 adapted for communication through the first wireless frequency f1 through an embedded device 2. The person skilled in the art understands that in one embodiment is the device 2 a separate device connected to the first mobile device 4a. The first mobile device 4a is located in an area with a skip zone 8 meaning that the first mobile device 4a is outside of range from a mobile network distributed from a cell tower 5. A second mobile device 4b is within range from the cell tower 5 and can thereby communicate through a conventional mobile telephone network, such as 3G, GSM, or LTE. The user of the first mobile device 4a intends to receive or perform a call wherein voice communication, preferably real time/live voice communication, is exchange between the first mobile device 4a and the second mobile device 4b. However, since the first mobile device 4a is outside of range from the conventional telephone network it would in prior art not be possible.

The first mobile device 4a comprises a device 2 which is enabled for communication through the first wireless communication frequency f1 which the mobile device 4a is in range of. The first distance dl is within the range of the node 1 meaning that the device 2 can communicate with the node 1. The user of the first mobile device 4a can thereby perform voice communication through the first wireless communication frequency f1, through the node 1 which modulates the signal to a second frequency f2 and transmits it to a main unit 3. This is conducted without changing the format of the signal meaning that the voice communication can be used on a conventional mobile network again without other modulation than between frequencies and between wired/wireless communication. The main unit 3 can distribute the signal to a network, such as the internet, and the signal can be transmitted via the conventional phone network through the cell tower 5 and be transmitted f3 to the second mobile device 4b.

FIG. 1 further illustrates that the first communication distance d1 is a distance illustrating range for communication from the node 1. The first communication distance d1 is longer than the second communication distance f2 between the node 1 and the main unit 3.

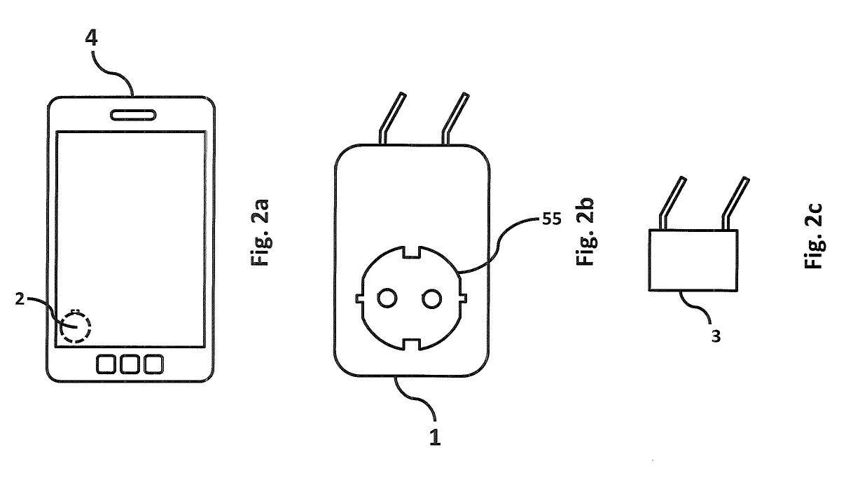

FIG. 2a illustrates a mobile device 4 with an embedded device 2. The mobile device 4 can be any form of mobile device 4 such as a cell phone 4, a smartphone 4, a tablet 4, a PDA 4, or any other form of mobile device 4. The mobile device 4 is in a preferred embodiment adapted for voice communication, such as telephone calls. The mobile device 4 thereby comprises at least one microphone and at least one speaker or other means for distributing sound to a user.

FIG. 2b illustrates a node 1 with means for connecting 55 the node 1 to a conventional power socket. The node 1 can for example further comprise antennas or other means for enabling communication. The node 1 is a node 1 in portable size meaning that it can be arranged in a domestic or office area without problems.

FIG. 2c illustrates a main unit 3 which can be any form of main unit 3 such as an access point or wireless router.

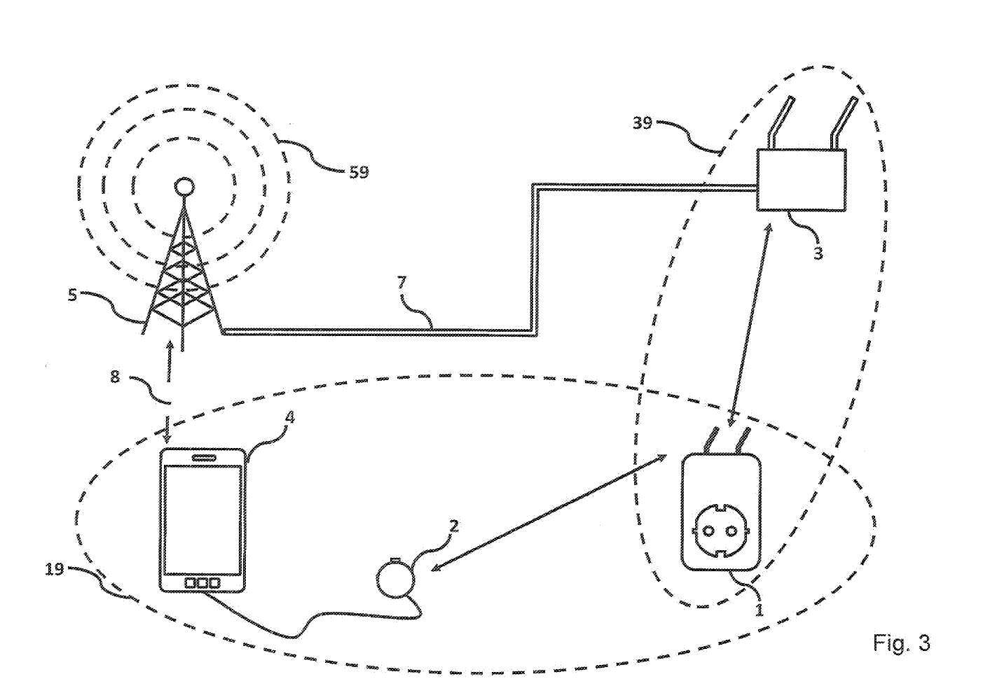

FIG. 3 illustrates a device 2, a node 1, a main unit 3, a mobile device 4, a cell tower 5, a conventional mobile network 59, a first wireless frequency network 19 and a second wireless frequency network 39. FIG. 3 further illustrates a skip zone 8 and how the cell tower 5 is connected to a network 7 being the same network as a main unit 3 is connected to, preferably the internet.

In one embodiment the device 2 is connected to a mobile device 4. The mobile device 4 can be any form of mobile device 4 such as a cell phone, a smartphone, a tablet, or any other form of personal communication device that is adapted for voice communication. The device 2 is in one embodiment connected to the mobile device 4 with a cable, in another embodiment with Bluetooth. In one embodiment is the device 2 adapted for voice communication and the mobile device 4 is not necessary. In another embodiment is the device 2 embedded in the mobile device 4.

Communication between the mobile device 4 and the conventional mobile network 59 is normally conducted directly through the cell tower 5 wherein the mobile device 4 connects through for example GSM, 3G, or LTE. However, in some instances such as the situation as illustrated in FIG. 3 the mobile device 4 is positioned at a geographic location wherein no coverage from the conventional mobile network 59 exists. For example, in one situation a skip zone 8 interfere the connection.

With the solutions as available in prior art the mobile device 4 would display “no service” and the user would need to find another location wherein a call could be made. However, the device 2 and thereby also the mobile device 4 are within the range of the network covered by the first wireless communication frequency of the node 1 and can thereby communicate via the first wireless communication frequency f1 which in accordance with the appended claims is adapted to enable voice communication. The mobile device 4 communicates through the device 2 to the node 1. The node 1 modulates the signal in order to send it to a main unit 3. The node 1 is arranged within a cover area 39 of the main unit 3 connecting through the second wireless communication frequency. The second wireless communication frequency can for example be WiFi. In one embodiment could the second communication frequency be adapted to be transmitted via a cable and thereby not wirelessly. In another embodiment could the node 1 communicate via some form of wired connection with the main unit 3, such as Ethernet. The communication is distributed further through the network 7, preferably the internet or a conventional telephone network, to the cell tower 5 and connected to the conventional mobile network 59. The person skilled in the art understands that the network 7 can be any form of network connecting the main unit 3 and the conventional mobile network 59 and that the path as described above is solely an example. The path could be directly to a base station 5 or any other form of connection path connecting the main unit 3 with the conventional mobile network 59.

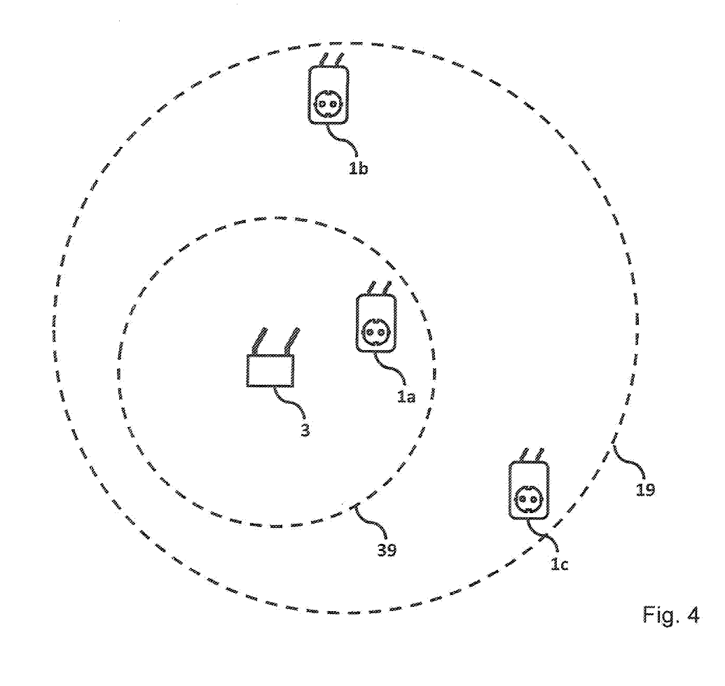

FIG. 4 illustrates an embodiment wherein a main unit 3 communicates with multiple nodes 1a, 1b, 1c. The first node 1a is within a second frequency communication range 39 for the main unit 3. The first node 1a can thereby communicate directly with the main unit 3. The second frequency communication range 39 is shorter than the first frequency communication range 19 and thereby the first node 1a in its first frequency communication range 19 covers two additional nodes, a second node 1b, and a third node 1c. Those nodes 1b, 1c can thereby communicate with the main unit 3 through the first node 1a.

FIG. 4 shows an illustrative example and any form of distributed network can be built with multiple main units 3 and/or multiple nodes 1.

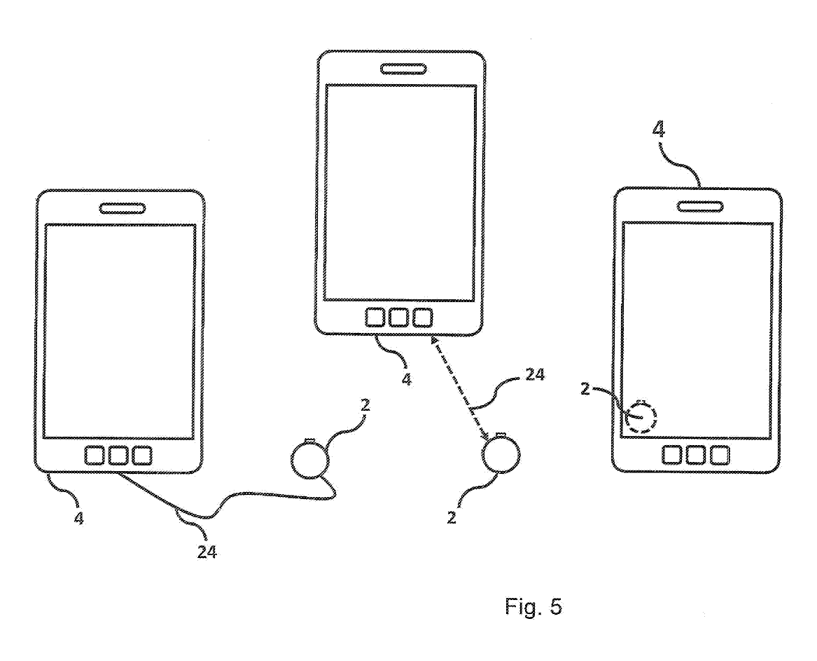

FIG. 5 illustrates a mobile device 3 connected through connection means 24 to a device 2. The connection means 24 can be any form of wired or wireless, preferably short range, connection means 24, such as Bluetooth, a USB-cable, or any other suitable connection means 24. In one embodiment is the device 2 embedded in the mobile device 4. FIG. 5 further illustrates different embodiments of a mobile device 4 coupled to a device 2.

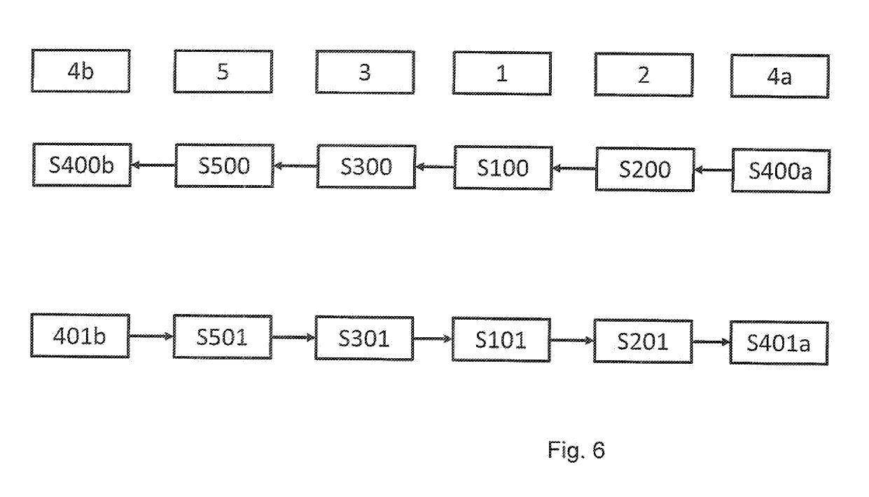

FIG. 6 illustrate a schematic view of an example how the system, method, mobile device, node, and device communicates. A user performs a call S400a with a mobile device 4a, the communication is sent S200 by a device 2 to a node 1 via a first wireless communication frequency f1. The node 1 modulates S100 the voice communication and transmits it to a main unit 3. The main unit 3 forwards S300 the communication to a base station 5, cell tower 5, or any other node 5 in a conventional mobile network 59. The base station 5 communicates the voice communication S500 to a second mobile device 4b through a conventional communication network 59. The second mobile device 4b provides S400b the communication to a second user for example through a speaker. The communication can also be reversed, in steps S401b, S501, S301, S101, S201, and S401a. The person skilled in the art understands that FIG. 6 solely is an illustrative example wherein one embodiment is illustrated. The communication is in one embodiment a real time telephone conversation and the steps as described in FIG. 6 can be performed simultaneously in both directions. In another embodiment is the second user of the second mobile device 4b out of range from the conventional mobile network 59 as well. Then the communication can be performed with a main unit 3, a node 1, and a device 2 in each end of the communication.

1. A node arranged to provide a network for positioning of a device, wherein the node is configured to transmit a position request to the device, receive a position response from the device, and calculate the distance to the device, and wherein the node further is adapted to enable transmission of voice communication through a first wireless communication frequency in the range between 300 and 1000 MHz, wherein the node further comprises means for communicating with a main unit through a second communication frequency, is adapted to modulate a voice communication from said first wireless communication frequency to said second communication frequency, and transmits the voice communication to said main unit.

2. The node according to claim 1, wherein the voice communication is preserved in a mobile phone format.

3. The node according to claim 1, wherein the second communication frequency is a wireless communication frequency.

4. The node according to claim 3, wherein the second wireless communication frequency is a frequency selected from any one of 2.4 GHz, 3.6 GHz, 4.9 GHz, 5 GHz, and 5.9 GHz.

5. The node according to claim 1, wherein the node is configured to transmit a position request to the device, receive a position response from the device, and calculate the distance to the device.

6. The node according to claim 5, wherein the first wireless communication frequency is used for transmitting the position request.

7. The node according to claim 5, wherein the distance to the device is used to determine the output power of the first wireless communication frequency.

8. The node according to claim 1, wherein the node determines an error rate for the voice communication and selects a band of said first wireless communication frequency based on the determined error rate.

9. The node according to claim 5, wherein the node selects a band of said first wireless communication frequency based on the distance.

10. The node according to claim 1, wherein the node further comprises means for connecting the node to a conventional power outlet socket.

11. The node according to claim 1, wherein the node comprises means for monitoring information paths.

12. A device arranged in a network for positioning of a device, wherein the device is adapted to be tracked by a node, receive a position request from the node, and transmit a position response to the node, and wherein the device further is adapted to communicate with a node through a first wireless communication frequency in the range between 300 and 1000 MHz, wherein the device is adapted to enable voice communication through said first wireless communication frequency when the device is out of range from a cellular network and the device transmits voice communication to said node and receives voice communication from said node.

13. The device according to claim 12, wherein the transmission power of the second frequency is determined based on a position received from the node.

14. The device according to claim 12, wherein the device is adapted to be connected to a mobile device.

15. The device according to claim 12, wherein the device is embedded in a mobile device.

16. The device according to claim 12, wherein the device further is out of range of communication through a second wireless communication frequency, and the first wireless communication frequency is of a lower frequency than the second wireless communication frequency.

17. The device according to claim 12, wherein the device is adapted to be tracked by a node, receive a position request from the node, and transmit a position response to the node.

18. The device according to claim 12, wherein the device is adapted to communicate with a second mobile device connected to a mobile network base station through the node and a main unit.

19. A system arranged to provide a network for positioning of a device, wherein the system further is adapted to enable transmission of voice communication through a first wireless communication frequency in the range between 300 and 1000 MHz, the system comprising a node, a device, a main unit and at least one mobile device, wherein the node is configured to transmit a position request to the device, the device is configured to respond with a position response, and the node is adapted to calculate the distance to the device based on the response, wherein the node and the device are adapted to communicate voice communication over said first wireless communication frequency, the node and the main unit are adapted to communicate through a second communication frequency, and the node is adapted to modulate the voice communication from said first wireless communication frequency to said second communication frequency.

20. The system according to claim 19, wherein the main unit further is adapted to communicate with a cellular network and the second communication frequency is a wireless communication frequency.

21. The system according to claim 20, wherein the communication technology between the main unit and the cellular network is chosen from any one of GSM, 3G, and LTE.

22. The system according to a claim 19, wherein the system comprises means for monitoring information paths.
